(19) United States
(12) Patent Application Publication
(10) Pub. No.: US 2018/0267217 A1
(43) Pub. Date: Sep. 20, 2018

(54) WAVELENGTH FILTER AND LIGHT RECEIVING ELEMENT

(71) Applicant: Kabushiki Kaisha Toshiba, Minato-ku (JP)

(72) Inventors: Haruhiko YOSHIDA, Funabashi (JP); Kazuya OHIRA, Nerima (JP); Hirotaka UEMURA, Kawasaki (JP); Kaori WARABI, Kawagoe (JP)

(73) Assignee: Kabushiki Kaisha Toshiba, Minato-ku (JP)

(21) Appl. No.: 15/688,032

(22) Filed: Aug. 28, 2017

(30) Foreign Application Priority Data
Mar. 15, 2017 (JP) 2017-050244

(51) Int. Cl. G02B 5/20; G01J 1/04

(52) U.S. Cl. CPC G02B 5/20; G02F 2203/055; G01J 1/0488

(57) ABSTRACT

A wavelength filter of an embodiment includes: a first layer having a plurality of first regions containing a first material and a plurality of second regions containing a second material having a refractive index higher than that of the first material, each of the second regions provided between each of the first regions; a second layer provided on the first layer and containing the first material; and a third layer having a plurality of third regions containing the first material, each of the third regions provided on the second layer above each of the first regions, and a plurality of fourth regions containing the second material, each of the fourth regions provided between each of the third regions.

### CROSS-REFERENCE TO RELATED APPLICATION

This application is based upon and claims the benefit of priority from Japanese Patent Application No. 2017-050244, filed on Mar. 15, 2017, the entire contents of which are incorporated herein by reference.

### FIELD

Embodiments described herein relate generally to a wavelength filter and a light receiving element.

### BACKGROUND

Laser radar (LiDAR) is one of key techniques of sensors playing a role of eyes in automatic driving. Technological development of integrated devices combining a light emitting element, a light receiving element, a wavelength filter, and an optical system for optical input/output control for use in these sensors is important.

In this case, a light-emitting element which is a light source of a sensor is a window selectively radiate light having a wavelength easily transmitted in the atmosphere (for example, within 0.2 μm and 1.2 μm, 1.6 μm and 1.8 μm, 2 μm and 2.5 μm, or 8 μm and 14 μm). The wavelength filter selectively receives light reflected from an object being an obstacle. In this manner, the sensor collects information necessary for determining a direction or the velocity of a moving body while measuring a distance to the object.

It is desirable that the wavelength filter has as high a transmittance as possible for reflected light from the light source. On the other hand, it is desirable that the wavelength filter has as low a transmittance as possible for light having other wavelengths and being noise.

### BRIEF DESCRIPTION OF THE DRAWINGS

FIG. 1 is a schematic cross-sectional view of a light receiving element of a first embodiment;

FIGS. 2A to 2D are schematic diagrams illustrating a method of manufacturing the light receiving element of the first embodiment;

FIGS. 3A to 3C are diagrams for explaining functions of a wavelength filter of the first embodiment; and

FIG. 4 is a schematic diagram of the main part of a light receiving element of a second embodiment when viewed from above.

### DETAILED DESCRIPTION

Embodiments of the present disclosure will be described below with reference to the drawings.

In the present specification, in order to indicate positional relationships of parts and other elements, an upward direction in a drawing is referred to as “up” and a downward direction in a drawing is referred to as “down”. In this specification, concepts of “up” and “down” are not necessarily terms indicating a relationship with the direction of gravity.

### First Embodiment

A wavelength filter of the present embodiment includes: a first layer having a plurality of first regions containing a first material and a plurality of second regions containing a second material having a refractive index higher than that of the first material, each of the second regions provided between each of the first regions; a second layer provided on the first layer and containing the first material; and a third layer having a plurality of third regions containing the first material, each of the third regions provided on the second layer above each of the first regions, and a plurality of fourth regions containing the second material, each of the fourth regions provided between each of the third regions.

A light receiving element of the present embodiment includes the wavelength filter described above, a light receiving unit, and a fourth layer provided between the wavelength filter and the light receiving unit and containing the first material.

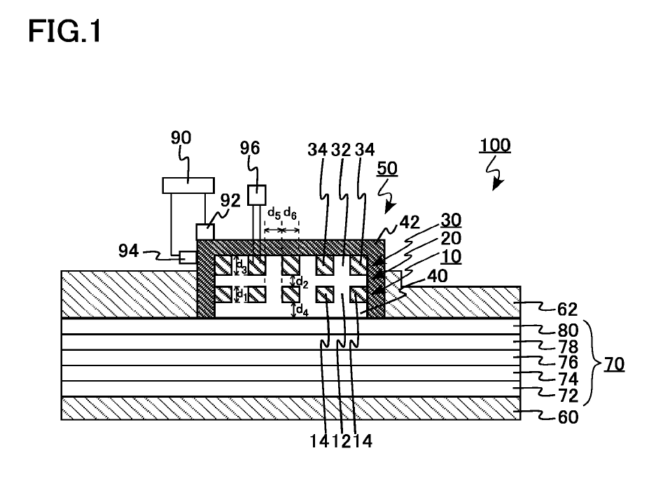

FIG. 1 is a schematic cross-sectional view of a light receiving element 100 of the present embodiment.

The light receiving element 100 includes a wavelength filter 50, a first electrode 60, a second electrode 62, a light receiving unit 70, a temperature control mechanism 90, and a current injecting mechanism 96.

The wavelength filter 50 has a first layer 10, a second layer 20, a third layer 30, and a protection film 42.

The first layer 10 has a plurality of first regions 12 and a plurality of second regions 14.

The third layer 30 has a plurality of third regions 32 and a plurality of fourth regions 34.

The light receiving unit 70 has a first contact layer 72, a first cladding layer 74, an active layer 76, a second cladding layer 78, and a second contact layer 80.

The temperature control mechanism 90 has a thermometer 92 and a heating mechanism 94.

The first regions 12 include the first material. The first material is, for example, silicon oxide (SiO₂).

Each of the plurality of second regions 14 is provided between each of the plurality of first regions 12. The second regions 14 include a second material having a refractive index higher than that of the first material. The second material is, for example, amorphous silicon.

The second layer 20 is provided on the first layer 10. The second layer 20 includes the first material.

The third layer 30 is provided on the second layer 20. Each of the plurality of third regions 32 is provided on each of the plurality of first regions 12. The third regions 32 include the first material. Each of the plurality of fourth regions 34 is provided between each of the plurality of third regions 32. The fourth regions 34 include the second material.

Each of the first layer 10 and the third layer 30 is a photonic crystal thin film of which refractive index periodically changes. The second layer 20 containing the first material having a low refractive index is provided between the first layer 10 and the third layer 30.

It is preferable that a film thickness d₁ of the first layer 10 and a film thickness d₃ of the third layer 30 are different from each other.

It is preferable that a film thickness d₂ of the second layer 20, a refractive index n₁ of the first material, and a wavelength λ of light incident on the wavelength filter satisfy the following mathematical formula (1).

[Mathematical Formula 1]

(1/(4n₁))·λ<d₂<(1/(2n₁))·λ (1)

The first cladding layer 74 is provided on the first contact layer 72. The active layer 76 is provided on the first cladding layer 74. The second cladding layer 78 is provided on the active layer 76. The second contact layer 80 is provided on the second cladding layer 78.

The first contact layer 72 is formed of, for example, n-type indium phosphide (InP). The first cladding layer 74 is formed of, for example, n-type indium aluminum gallium arsenic (InAlGaAs). The active layer 76 is, for example, an InAlGaAs/InAlGaAs multiple quantum well layer. The second cladding layer 78 is formed of, for example, p-type InAlGaAs. The second contact layer 80 is formed of, for example, p-type InP. Note that a configuration of the light receiving unit 70 is not limited to the above.

The wavelength filter 50 is provided on the light receiving unit 70.

The first electrode 60 is electrically connected to the first contact layer 72. The first electrode 60 is an n-electrode. The second electrode 62 is electrically connected to the second contact layer 80. The second electrode 62 is a p-electrode.

The fourth layer 40 is provided between the wavelength filter 50 and the light receiving unit 70. The fourth layer 40 includes the first material.

It is preferable that a film thickness d₄ of the fourth layer 40, the refractive index n₁ of the first material, and the wavelength λ of light incident on the wavelength filter 50 satisfy the following mathematical formula (2).

[Mathematical Formula 2]

exp(−2πn₁d₄/λ)<0.5 (2)

The protection film 42 is provided around the wavelength filter 50 and the fourth layer 40. The protection film 42 contains, for example, silicon oxide or silicon nitride (SiN).

The temperature control mechanism 90 is connected to the thermometer 92 and the heating mechanism 94. The thermometer 92 and the heating mechanism 94 are provided in contact with, for example, the wavelength filter 50. The thermometer 92 measures the temperature of the wavelength filter 50. The heating mechanism 94 heats the wavelength filter 50. The heating mechanism 94 is, for example, a known heater. The temperature control mechanism 90 controls output of heating by the heating mechanism 94 on the basis of the temperature of the wavelength filter measured by the thermometer 92. In this manner, the temperature control mechanism 90 controls the temperature of the wavelength filter.

The current injecting mechanism 96 is connected to the second regions 14 or the fourth regions 34. The current injecting mechanism 96 injects a current or a carrier into the second regions 14 or the fourth regions 34. As a result, heat is generated in the second regions 14 or the fourth regions 34. Controlling the amount of a current or a carrier allows the temperature of the wavelength filter 50 to be controlled.

A circuit substrate can be used for the temperature control mechanism 90; however, without being limited to a circuit substrate, for example, a microprocessor mainly including a central processing unit (CPU), a read only memory (ROM) for storing a processing program, a random access memory (RAM) for temporarily storing data, an input/output port, and a communication port may be used.

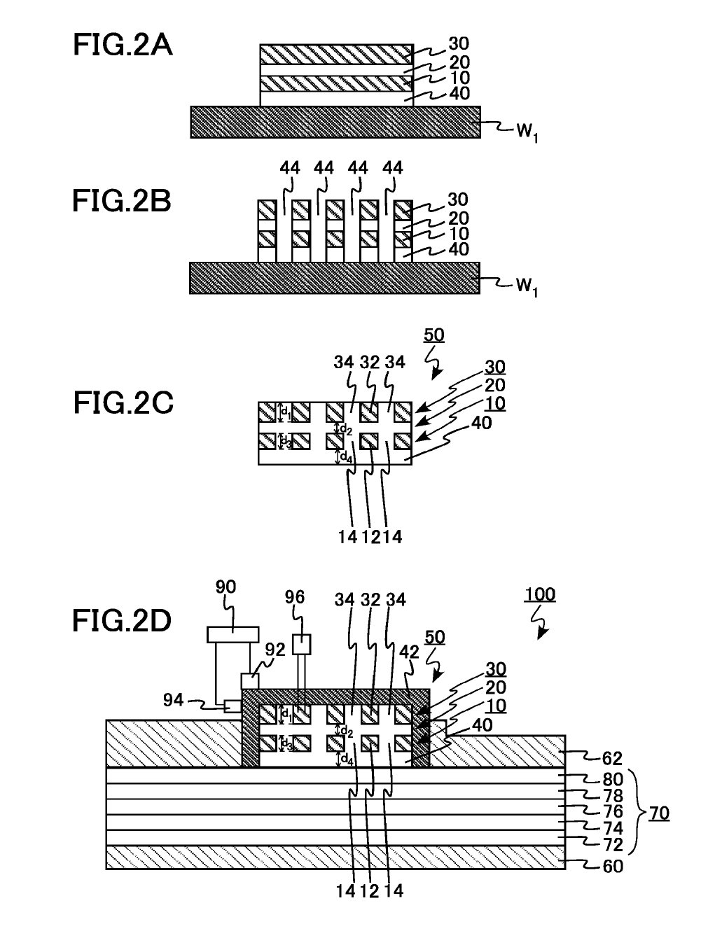

Next, a method for manufacturing the light receiving element of the present embodiment will be described. FIGS. 2A to 2D are schematic diagrams illustrating a method of manufacturing the light receiving element of the present embodiment.

A method of manufacturing a wavelength filter of the present embodiment includes: forming a fourth layer containing the first material; forming, on the fourth layer, a first layer containing the second material having a refractive index higher than that of the first material; forming, on the first layer, a second layer containing the first material; forming, on the second layer, a third layer containing the second material; forming, on the fourth layer, openings formed by a grating of a plurality of grooves or holes and having constant periodicity by removing a part of the first layer, the second layer, and the third layer; forming, in the first layer, the first regions containing the first material by forming the first material in the openings and the second regions containing the second material, each of the plurality of second regions provided between each of the plurality of first regions; and forming, in the third layer, the third regions containing the first material, each of the plurality of third regions provided above each of the plurality of first regions and the fourth regions containing the second material, each of the plurality of fourth regions provided between each of the plurality of third regions.

The method of manufacturing the light receiving element of the present embodiment includes: forming the light receiving unit; joining the wavelength filter and the light receiving unit together; forming the protection film around the wavelength filter and the fourth layer; forming the first electrode and the second electrode; and connecting the temperature control mechanism and the current injecting mechanism to the wavelength filter.

First, a fourth layer (first layer) 40 containing the first material is formed on a first substrate W₁ such as a Si substrate. Next, a first layer (second layer) 10 containing the second material having a refractive index higher than that of the first material is formed on the fourth layer 40. The second layer (third layer) 20 containing the first material is then formed on the first layer 10. Next, a third layer (fourth layer) 30 containing the second material is formed on the second layer 20 (FIG. 2A).

Next, a part of the first layer 10, the second layer 20, and the third layer 30 is removed by, for example, lithography and dry etching to form openings 44 having constant periodicity on the fourth layer 40. The openings 44 is formed by a grating of a plurality of grooves or holes (FIG. 2B).

Next, the first material is formed in the removed openings 44 described above. Thereby, in the first layer 10, a plurality of first regions 12 containing the first material and a plurality of second regions 14 containing the second material are formed. Each of the plurality of second regions 14 is provided between each of the plurality of first regions 12. Furthermore in the third layer 30, a plurality of third regions 32 containing the first material and a plurality of fourth regions 34 containing the second material are formed. Each of the plurality of third regions 32 is provided above each of the plurality of first regions 12, and each of the plurality of fourth regions 34 is provided between each of the plurality of third regions 32. Next, the first substrate W₁ is removed. Thereby, the wavelength filter 50 of the present embodiment is manufactured (FIG. 2C).

Next, the second contact layer 80 is formed on a second substrate W₂ such as a group III-V compound semiconductor substrate. Next, the second cladding layer 78 is formed on the second contact layer 80. The active layer 76 is then formed on the second cladding layer 78. Next, the first cladding layer 74 is formed on the active layer 76. The first contact layer 72 is then formed on the first cladding layer 74. In this manner, the light receiving unit 70 is formed on the second substrate W₂.

Then, the wavelength filter 50 and the light receiving unit 70 are joined together such that the fourth layer 40 and the second contact layer 80 are in contact with each other. Next, the first substrate and the second substrate are removed.

Next, the protection film 42 is formed around the wavelength filter 50 and the fourth layer 40. Next, the first electrode 60 electrically connected to the first contact layer 72 and the second electrode 62 electrically connected to the second contact layer 80 are formed. Next, the temperature control mechanism 90 and the current injecting mechanism 96 are connected to the wavelength filter 50. Thereby, the light receiving element 100 of the present embodiment is manufactured (FIG. 2D).

Next, functions and effects of the present embodiment will be described.

As in the present embodiment, inclusion of the layers formed of two photonic crystal thin films having a refractive index periodically varying and the second layer 20 containing a material having a low refractive index and provided between the two photonic crystal thin films described above enables implementing the wavelength filter 50 and the light receiving element 100 having high directivity, a narrow band, and high sensitivity and facilitating integration.

Hereinafter, the functions and the effects will be described in more detail.

As a wavelength filter, it is desirable that the wavelength filter has high transmittance for reflected light from a light source while cutting off light having other wavelengths and being noise as much as possible. For this purpose, for example, there is a method of using an etalon or a resonator in which a multilayer reflective film such as a distributed Bragg reflective film is combined.

However, the element becomes thick and directivity drops. In addition, since a target wavelength of the wavelength filter is allowed to be variable and stabilized, the configuration becomes complicated.

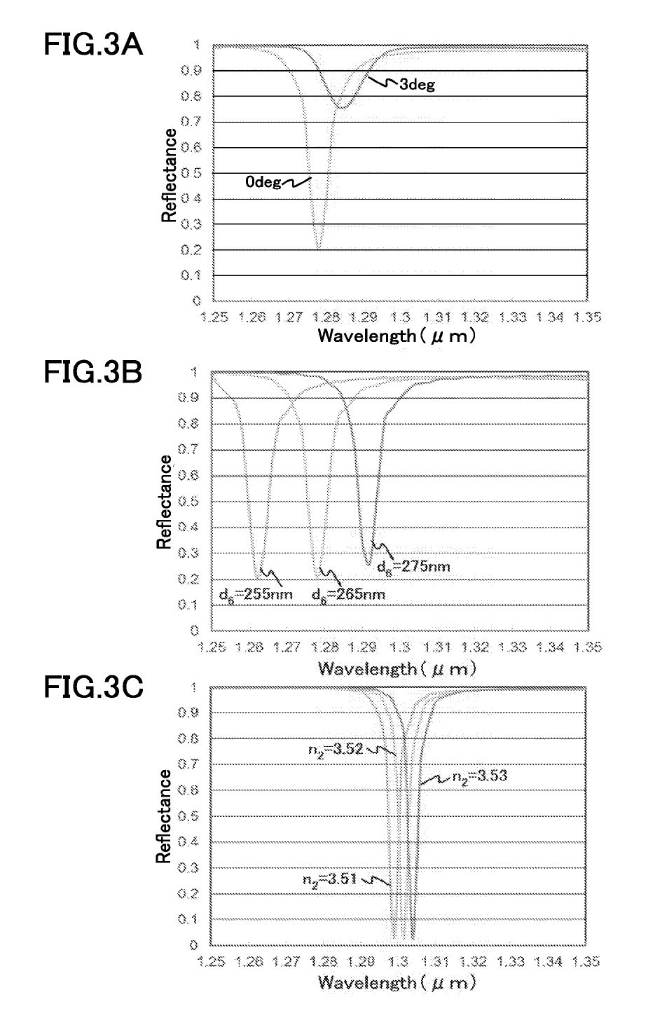

FIGS. 3A to 3C are diagrams for explaining functions of the wavelength filter 50 of the present embodiment.

FIG. 3A is a diagram illustrating wavelength dependency of the reflectance of the wavelength filter 50 when light is incident in a direction perpendicular to the film thickness of the third layer 30. When the incident angle was 0 degrees, the transmittance was about 80%. Meanwhile, when the incident angle was 3 degrees, the transmittance decreased to 24%. As the above, the wavelength filter 50 of the present embodiment has high directivity. The transmittance was about 80% and the wavelength band was about 0.006 μm when the incident angle was 0 degrees. In this manner, the wavelength filter 50 of the present embodiment implements a narrow-band and highly sensitive wavelength filter.

FIG. 3B is a diagram illustrating wavelength dependence of the reflectance when d₆ is changed with the sum d₅+d₆ kept constant where d₅ denotes the length of the first regions 12 and the length of the third regions 32 and d₆ denotes the length of the second regions 14 and the length of the fourth regions 34 in a direction perpendicular to the film thickness of the third layer 30.

At d₆=255 nm, a wavelength at which the reflectance is the smallest, that is, a target wavelength of the wavelength filter 50 was 1.262 μm. Meanwhile, at d₆=265 nm and d₆=275 nm, a target wavelengths of the wavelength filter 50 changed to 1.278 μm and 1.292 μm, respectively.

When a target wavelength is changed in the multilayer reflective film described above, the film thickness, the number of laminated layers, and the like of the multilayer reflective film are changed, thus resulting in a complicated structure. However, in the wavelength filter 50 of the present embodiment, a target wavelength can be easily changed by changing the length of d₅ or d₆. Therefore, by changing a mask pattern etc. of lithography with the same film structure, a target wavelength can be changed.

FIG. 3C is a diagram illustrating wavelength dependence of the reflectance when a refractive index n₂ of the second material is changed. When the refractive index n₂ of the second material was 3.51, a target wavelength of the wavelength filter 50 was 1.291 μm. When the refractive index n₂ of the second material was 3.52 and 3.53, target wavelengths of the wavelength filter 50 changed to 1.302 μm and 1.304 μm, respectively. In this manner, also by changing the refractive index n₂ of the second material, a target wavelength can be easily changed.

The wavelength filter 50 of the present embodiment includes two photonic crystal thin films and the second layer 20 provided between the two photonic crystal thin films described above. This allows the wavelength filter 50 to be thinner as compared to the multilayer reflective film described above. This facilitates integration.

When the film thickness d₂ of the first layer 10 is equivalent to the film thickness d₃ of the third layer 30, light disadvantageously resonates and interferes within the wavelength filter 50. In order to suppress the above interference, it is preferable that the film thickness d₁ of the first layer 10 and the film thickness d₃ of the third layer 30 are different from each other.

When the film thickness d₂ of the second layer 20, the refractive index n₁ of the first material, and the wavelength λ of light incident on the wavelength filter 50 satisfy the following mathematical formula (1), selectivity of a target wavelength of light can be increased.

[Mathematical Formula 1]

(1/(4n₁))·λ<d<(1/(2n₁))·λ (1)

By including the temperature control mechanism 90, the refractive index of the material can be changed. Therefore, as illustrated in FIG. 3C described above, a target wavelength of the wavelength filter 50 can be changed. Furthermore, when the temperature of the environment in which the wavelength filter 50 is installed changes, a target wavelength also changes. Therefore, inclusion of the temperature control mechanism 90 enables control such that a target wavelength of the wavelength filter 50 does not change depending on the temperature of the environment.

By further including the current injecting mechanism 96 electrically connected to the second regions 14 or the fourth regions 34, a carrier can be injected into the second regions 14 or the fourth regions 34 to generate heat to change the refractive index of the second regions 14 or the fourth regions 34. This allows a target wavelength of the wavelength filter 50 to be changed.

Note that a target wavelength of the wavelength filter 50 can be controlled to be at a predetermined wavelength by changing the amount of injection of a carrier. For example, when a carrier with a high density of 10¹⁸/cm⁻³ or more is injected, a refractive index change of several tenths percentage or more is generated due to dependence on the carrier density of the refractive index. Therefore, a target wavelength can be changed also by a change in the refractive index.

A light receiving element including the wavelength filter 50 of the present embodiment, the light receiving unit 70, and the fourth layer 40 provided between the wavelength filter 50 and the light receiving unit 70 and containing the first material enables provision of the light receiving element 100 having high directivity, a narrow band, and high sensitivity and facilitating integration.

When the film thickness d₄ of the fourth layer 40 is excessively small, the wavelength filter 50 does not function properly. When the film thickness d₄ of the fourth layer 40, the refractive index n₁ of the first material, and the wavelength λ of light incident on the wavelength filter 50 satisfy the following mathematical formula (2), a light receiving element having the wavelength filter 50 functioning normally can be provided.

[Mathematical Formula 2]

exp(−2πn₁d₄/λ)<0.5 (2)

In this manner, according to the present embodiment, the wavelength filter and the light receiving element having high directivity can be provided.

### Second Embodiment

A wavelength filter of the present embodiment is different from the wavelength filter of the first embodiment in that the second regions 14 or the fourth regions 34 have different widths. Here, descriptions on the same points as those of the first embodiment are omitted.

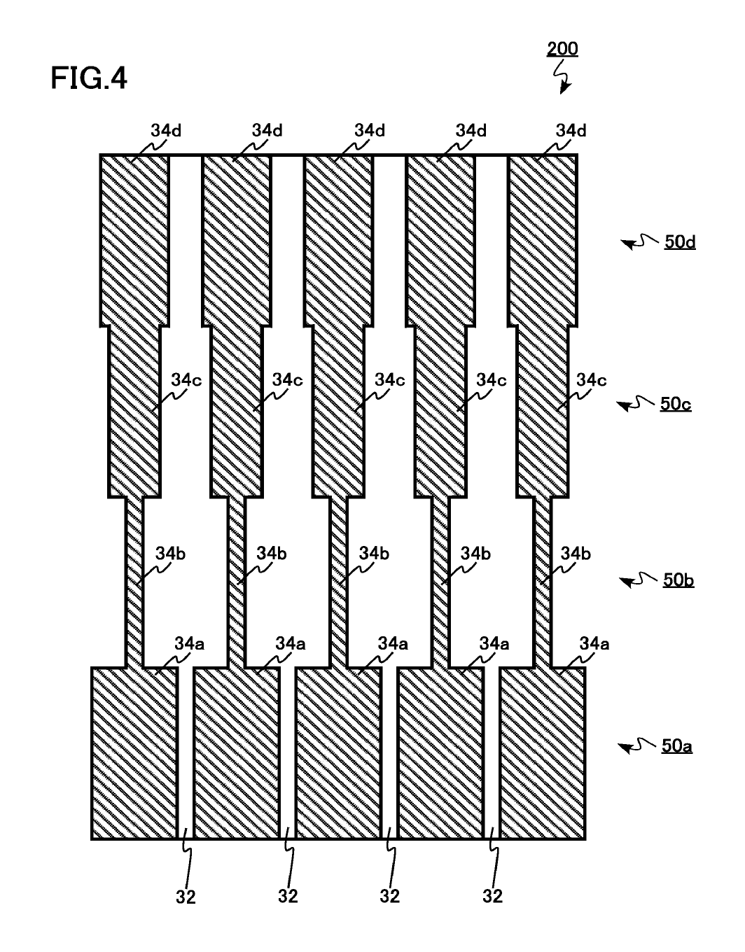

FIG. 4 is a schematic diagram of the main part of the light receiving element 200 of the present embodiment when viewed from above. The light receiving element 200 includes a wavelength filter 50a, a wavelength filter 50b, a wavelength filter 50c, and a wavelength filter 50d.

The width of fourth regions 34a of the wavelength filter 50a, the width of the fourth regions 34b of the wavelength filter 50b, the width of the fourth regions 34c of the wavelength filter 50c, and the width of the fourth regions 34d of the wavelength filter 50d are different from each other. Note that the same applies to first regions 12 and second regions 14. This allows a target wavelength of the wavelength filter 50a, a target wavelength of the wavelength filter 50b, a target wavelength of the wavelength filter 50c, and a target wavelength of the wavelength filter 50d to be different from each other.

In the case of a wavelength filter using the multilayer reflective film described above, the number of laminated layers or the film thickness of the multilayer reflective film are different depending on a target wavelength. Therefore, a structure and a manufacturing process become complicated.

In the wavelength filter of the present embodiment, even in the same layer structure (first layer 10, second layer 20, and third layer 30), wavelength filters having different target wavelengths can be aligned by changing the width of the first regions 12, the second regions 14, the third regions 32, or the fourth regions 34 by lithography, dry etching, or the like. In other words, arraying of the wavelength filter is facilitated.

A wavelength filter of at least one of the embodiments described above includes: a first layer having a plurality of first regions containing a first material and a plurality of second regions containing a second material having a refractive index higher than that of the first material, each of the second regions provided between each of the first regions; a second layer provided on the first layer and containing the first material; and a third layer having a plurality of third regions containing the first material, each of the third regions provided on the second layer above each of the first regions, and a plurality of fourth regions containing the second material, each of the fourth regions provided between each of the third regions. This enables provision of a wavelength filter and a light receiving element having high directivity.

While certain embodiments have been described, these embodiments have been presented by way of example only, and are not intended to limit the scope of the inventions. Indeed, the wavelength filter and the light receiving element described herein may be embodied in a variety of other forms; furthermore, various omissions, substitutions and changes in the form of the devices and methods described herein may be made without departing from the spirit of the inventions. The accompanying claims and their equivalents are intended to cover such forms or modifications as would fall within the scope and spirit of the inventions.

What is claimed is:

1. A wavelength filter, comprising:
a first layer having a plurality of first regions containing a first material and a plurality of second regions containing a second material having a refractive index higher than that of the first material, each of the second regions provided between each of the first regions;
a second layer provided on the first layer and containing the first material; and
a third layer having a plurality of third regions containing the first material, each of the third regions provided on the second layer above each of the first regions, and a plurality of fourth regions containing the second material, each of the fourth regions provided between each of the third regions.

2. The wavelength filter according to claim 1, wherein a film thickness d₁ of the first layer and a film thickness d₃ of the third layer are different from each other.

3. The wavelength filter according to claim 1, wherein the first material is silicon oxide, and the second material is amorphous silicon.

4. The wavelength filter according to claim 1, wherein a film thickness d₂ of the second layer, a refractive index n₁ of the first material, and a wavelength λ of light incident on the wavelength filter satisfy the following inequality:
(1/(4n₁))·λ<d₂<(1/(2n₁))·λ (1).

5. The wavelength filter according to claim 1, further comprising a temperature control mechanism.

6. The wavelength filter according to claim 5, further comprising a thermometer and a heating mechanism connected to the temperature control mechanism.

7. The wavelength filter according to claim 1, further comprising a current injecting mechanism.

8. The wavelength filter according to claim 1, wherein widths of the second regions or widths of the fourth regions are different.

9. A light receiving element, comprising:
a wavelength filter according to claim 1;
a light receiving unit; and
a fourth layer containing the first material and provided between the wavelength filter and the light receiving unit.

10. The light receiving element according to claim 9, wherein a film thickness d₄ of the fourth layer, the refractive index n₁ of the first material, and a wavelength λ of light incident on the wavelength filter satisfy the following inequality:
exp(−2πn₁d₄/λ)<0.5 (2).

11. The light receiving element according to claim 9, wherein the light receiving unit includes: a first contact layer; a first cladding layer provided on the first contact layer; an active layer provided on the first cladding layer; a second cladding layer provided on the active layer; and a second contact layer provided on the second cladding layer.

12. The light receiving element according to claim 9, further comprising a protection film provided around the wavelength filter and the fourth layer.

13. The light receiving element according to claim 11, further comprising: a first electrode electrically connected to the first contact layer; and a second electrode electrically connected to the second contact layer.

14. A method of manufacturing a wavelength filter, comprising:
forming a first layer containing a first material;
forming, on the first layer, a second layer containing a second material having a refractive index higher than that of the first material;
forming, on the second layer, a third layer containing the first material;
forming, on the third layer, a fourth layer containing the second material;
forming, on the first layer, openings formed by a grating of a plurality of grooves or holes and having constant periodicity by removing a part of the second layer, the third layer, and the fourth layer;
forming, in the second layer, a plurality of first regions containing the first material by forming the first material in the openings and a plurality of second regions containing the second material, each of the second regions provided between each of the first regions; and
forming, in the fourth layer, a plurality of third regions containing the first material, each of the plurality of third regions provided above each of the first regions and a plurality of fourth regions containing the second material, each of the plurality of fourth regions provided between each of the third regions.
